(19) United States
(12) Patent Application Publication
(10) Pub. No.: US 2023/0177364 A1
(43) Pub. Date: Jun. 8, 2023

(54) SMART TELEMETRY METHOD BASED STATE TRANSITION PREDICTION

(71) Applicant: EMC IP Holding Company LLC, Hopkinton, MA (US)

(72) Inventors: Rahul Deo Vishwakarma, Bangalore (IN); Bing Liu, Tianjin (CN); Hemant Ramesh Gaikwad, Pune (IN)

(21) Appl. No.: 17/657,800

(22) Filed: Apr. 4, 2022

(30) Foreign Application Priority Data
Dec. 4, 2021 (IN) 202111056316

(51) Int. Cl. G06N 5/04; G06N 7/00

(52) U.S. Cl. CPC G06N 5/04; G06N 7/005

(57) ABSTRACT

One example method includes telemetry based state transition and prediction. Telemetry data is used to generate a transition matrix. The transition matrix is used to predict a state transition for a system or an application. A log level is predictively adjusted based on the transition matrix. The telemetry data is thus adaptively collected based on predicted transitions.

### FIELD OF THE INVENTION

Embodiments of the present invention generally relate to data protection and data protection operations. More particularly, at least some embodiments of the invention relate to systems, hardware, software, computer-readable media, and methods for storing data efficiently and to reducing the amount of stored data.

### BACKGROUND

Dark data often refers to data that organizations collect, store, and generally do not use. As a result, dark data consumes storage space and incurs costs that could otherwise be avoided. In other words, the cost of storing dark data is more than the value of the dark data in the long run.

Unused telemetry data is an example of dark data. For example, when data is collected and stored as telemetry data, there is a good chance that 90% of the data will be untouched and can be categorized as dark data. One consequence is that a data storage center may waste 90% of their energy on dark data. This clearly suggests that costs are too high from both a storage and an energy conservation perspective. Systems and methods are needed to control the generation of dark data and to prevent the costs and energy waste incurred by storing dark data.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a system including a logging mechanism configured to adaptively change a log level performed with respect to an application;

FIG. 2 discloses aspects of a state transition diagram and a transition probability matrix;

FIG. 3 discloses aspects of a relationship between log levels and a state transition matrix;

FIG. 4 discloses aspects of a performance regression telemetry;

FIG. 5 discloses aspects of a method for telemetry based state transitions for logging operations;

FIG. 6 discloses aspects of a telemetry engine; and

FIG. 7 discloses aspects of a computing device and/or a computing system.

### DETAILED DESCRIPTION OF SOME EXAMPLE EMBODIMENTS

Embodiments of the present invention generally relate to application and data collection operations. More particularly, at least some embodiments of the invention relate to systems, hardware, software, computer-readable media, and methods for reducing or controlling the amount of dark data generated, collected, and/or stored and generating improved analytics to generate insights for managing dark data, collected data, and the like or combination thereof.

By way of example only, telemetry data refers to data that is collected on site and transmitted to another point or location. The logs generated in the course of performing data protection operations are examples of telemetry data. Logs can be used for various purposes including for generating insights regarding data protection, troubleshooting, and predicting potential issues.

For example, the logs can be processed with machine learning and/or a Markov process. Embodiments of the invention relate to a smart telemetry method using state transition predictions to set log or logging levels. By implementing variable logging, embodiments of the invention can intelligently collect data in a manner that allows log levels to be set in advance more effectively and in a manner that reduces dark data. By anticipating a state transition, the log level can be increased/reduced as appropriate for the anticipated state.

As telemetry data is collected, the data may be analyzed in the context of, by way of example, a Markov chain and a transition probability, which may be embodied as a transition probability table (or transition matrix). By modeling the system as states, the transition matrix can be updated. This allows the next state of a system to be predicted based on the telemetry data. Advantageously, the log level can be changed in advance of the expected change in state. By changing the log level, the appropriate amount of data is collected that allows the expected state to be properly analyzed, troubleshot, or the like. Thus, if the transition probability table indicates that the next state is an anomaly or an error, the log level is set such that logs are collected that allow the anomaly to be analyzed or resolved.

For example, the telemetry data of a data protection system may be generated by performing logging operations. When the log level is too high, the amount of dark data increases because too much data is being collected and much of the data may never be used. This may consume storage and waste energy. When the logging level is too low, the logging data needed for predictive telemetry and other purposes may not be collected. A log level that is too low may frustrate the ability to perform troubleshooting operations, data protection operations, adequate logging operations, or the like.

Embodiments of the invention use telemetry data, such as system logs, for predictive purposes. More specifically, historical log data can be used or analyzed to determine probabilities. These probabilities may be represented in a Markov chain and/or a transition probability structure, such as a transition matrix.

Once the transition matrix is constructed using historical data, the transition probability table can be used for predictive purposes. Subsequent telemetry data can also be used to update or augment the transition matrix.

When the predicted transition is to an anomalous state, the log level may be increased to ensure that adequate log data to diagnose or analyze the anomaly is collected. Over time, embodiments of the invention reduce the dark data footprint, which improves storage efficiency and reduces energy costs. Further, variable data collection levels allow for telemetry data to be selectively collected in accordance based on overall system statistics. More relevant and better data facilitates improved quality analytics better insights.

Embodiments of the invention further relate to a variable logging mechanism that may use telemetry data as input to a machine learning model and/or to a Markov process to provide actionable insights or to predict the next state. The variable logging mechanism is dynamically adaptive within the system. In one example, the variable logging mechanism is based on a Markov chain model and a state transition matrix and may include machine learning.

The chain model may describe a sequence of possible events or states in which the probability of each state depends only on a previously attained state. Embodiments of the invention provide a variable level of logging that is dependent on the system state. Further, the log level is proactively changed based, in part, on the predicted state transition, which prediction is based on probabilities.

The level of logging that is enabled may depend on the transition probability state of the same state in the log based on the analytics previously performed using the log data and/or recent telemetry data. In other words, the analysis of the existing logs allows a state transition matrix to be generated and allows the log level to be changed prior to the event that may require a different log level.

Embodiments of the invention thus relate to a logging mechanism that may be designed for a specific product or system (e.g., Dell Data Domain or PPDM). The logs are directed to a logging mechanism that captures the incoming logs and store the logs in a database. Analytics can be performed on the logs using other compute resources, such as cloud compute resources. This offloads processing requirements from the application itself in some embodiments.

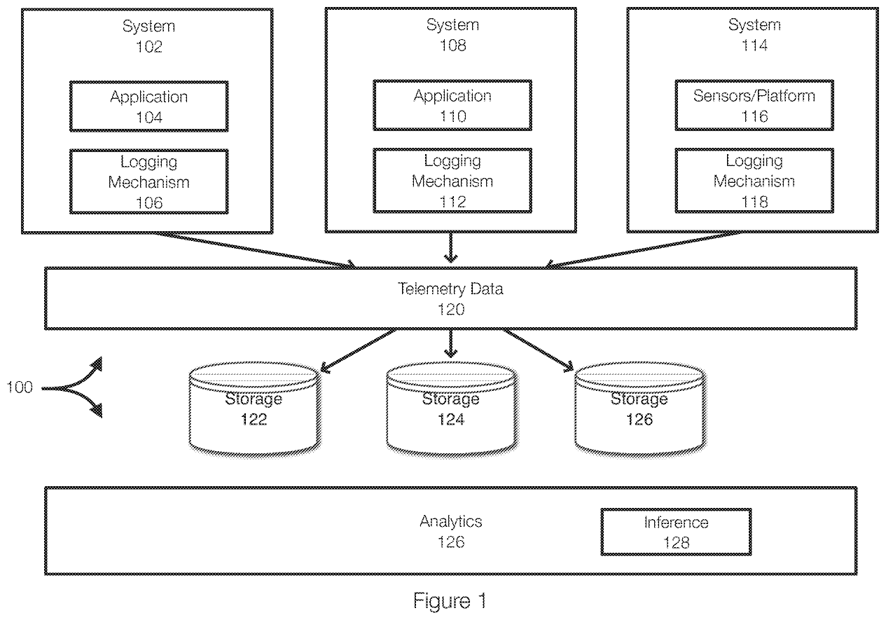

FIG. 1 illustrates an example of a system in which variable logging is implemented. FIG. 1 illustrates a system 100 that includes multiple systems 102, 108 and 114. The systems 102, 108, and 114 may be related or unrelated. The system 102 includes an application 104 (e.g., a data protection system) that may include virtual/physical machines or that may be implemented in other manners such as a container. The application 104 may include executable code and/or be implemented as a physical/virtual appliance configured to perform data protection operations such as backup and recovery operations.

The logging mechanism 106, in this example, is configured to capture (or generate) logs in a variable manner and may be part of the application 104. The logging mechanism 106 may include or have access to a state transition matrix that may be used by the logging mechanism 106 to set different log levels.

By way of example and not limitation, the application 104 may associated with 9 different log levels: D¹-D⁹. If D₁ is the lowest log level (the level that results in the smallest logs), then the size of the log varies as follows:

f_{size}(D¹)<f_{size}(D²)<f_{size}(D³)<, . . . ,f_{size}(D⁹).

Embodiments of the invention allow specific log levels to be set or implemented based on the transition probability matrix. The logging mechanism 106 is dynamically adaptive and may be dependent on the overall information and statistics of the system 102 and/or the application 104. If the statistical analysis suggests that, in the long term, steady state will be achieved, then the log level can be reduced. Alternatively, if steady state is not expected, the log level may be increased.

This allows the log level to be adapted such that, in the event that the state changes, the log level is sufficient to capture the necessary information.

The system 108 is similarly configured with an application 110 and a logging mechanism 112. The system 114 may include a systems of sensors (e.g., Internet of Things (IoT) sensors) and a streaming platform 116. The logging mechanism 118 may be adapted to perform variable logging for the sensors/platform 116. In the case of the sensors/platform 116, the telemetry data may be the data generated by the sensors. The logging mechanism 118 may include log levels that correspond to sampling times. Depending on the state, the sampling rate may be increased/decreased based on the corresponding transition matrix.

Thus, the log data collected from the systems 102, 108, and 114 constitutes telemetry data 120 that is directed to and stored in storage 122, 124, and/or 126. Each of the storage 122, 124, and 126 may represent a datacenter, a specific portion of the same datacenter, a cloud bucket, container or the like. For example, the telemetry data from the system 102 may be directed to the storage 122, the telemetry data from the system 108 may be directed to the storage 124, and the telemetry data from the system 114 may be directed to the storage 126. Analytics 126 can then be performed for the telemetry data 120 stored in the storage 122, 124, and/or 126 to generate inferences 128, to generate/update transition matrices, or the like.

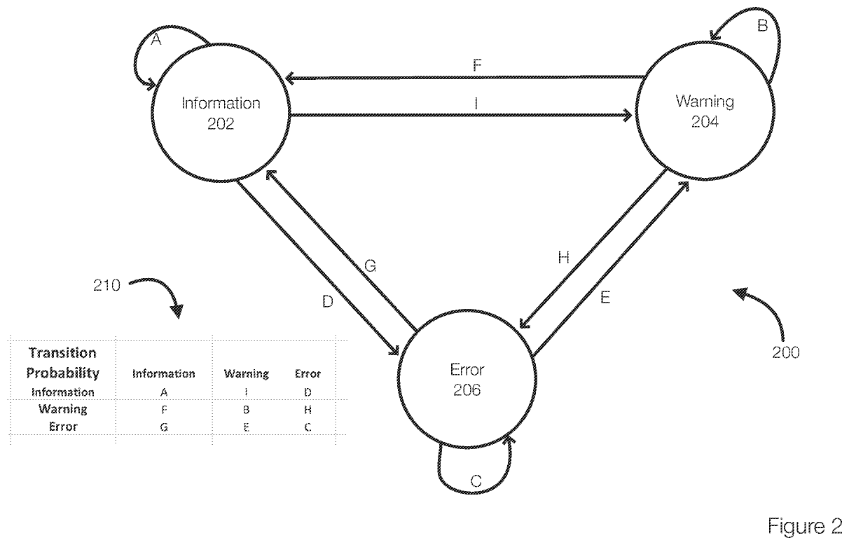

FIG. 2 illustrates an example of a transition probability diagram or a Markov chain. The diagram 200 is presented by way of example only. The diagram 200 may include any number of states. In this example, the diagram 200 includes three states: information 202 (I), warning 204 (W), and error 206 (E). The arrows, labeled A, B, C, D, E, F, G, H, and I represent transitions from one state to another state and each label may also represent a probability. For example, the probability of transitioning from error 206 to information 202 is G. These probabilities may change over time due to changing circumstances. FIG. 2 also illustrates a transition matrix 210, which identifies the probabilities associated with state transitions.

In the context of information 202, warning 204 and error 206, the current state may be derived from the system state. A system may be running at time T. If the log is observed or analyzed, the initial state may be derived by examining a window of time (e.g., the last 5 minutes of the log). The log may contain 80% information 202 messages, 15% warning 204 messages, and 5% error 206 messages.

This information can be used to construct an initial transition probability. Based on the information from a previous step, the log level is changed. The logs may then be processed as telemetry data. Thus, the initial state of a system can be generated from a current or most recent portion of a log. Once the initial state is determined, the transition matrix, which may have been generated from historical telemetry data, can be used to determine the most likely next state. The log level is adjusted based on the anticipated next state.

If s₁ is an initial state of the system,

sₜ=sₜ₋₁(P)=sₜ₋₂(P)(P)= . . . =s₁(P)^{t-1}.

In one example, an estimate for the next day is

s₂=s₁P, which corresponds to in this example:

[W,E,I]=[0.2325,0.4675,0.3218]

The estimate for the next day is

s₃=s₂P, which correspond to in this example:

[W,E,I]=[0.4123,0.3134,0.2391].

System equilibrium or steady state may be:

x₁=0.88x₁+0.15x₂+0.23x₃

x₂=0.12x₁+0.85x₂+0.64x₃

x₁+x₂+x₃=1.

Solving for variables results in

x₁(W)=0.15

x₂(E)=0.24, and

x₃(1)=0.61

Although changing circumstances may change the transition matrix 210 over time, this analysis indicates how W/E/I is expected to grow over time and what the maximum W/E/I is on the system 200. In other words, a system moving from a current state to steady state can be expected to grow or change in a manner what moves W, E, and I towards the steady state

Further, in this example, the product and sum of each state 202, 204, 206 with a constant is always less than or equal to Z. The product and sum of information 202 and warning 204 is always less than or equal to the product of error 206 with a constant positive integer. Z is an integer ranging between 0.1 and 0.9.

In other words:

C₁(W)+C₂(E)+C₃(I)≤1 and C₃(I)+C₁(W)≤C₂(E);

C₂(E)+C₁(W)≤Z; and

Z is between 0 and 1.

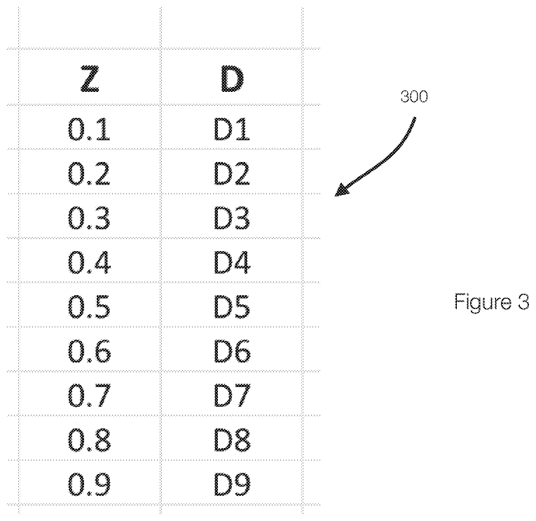

In one example, the value of Z can be mapped to the log levels. FIG. 3 illustrates a mapping of Z to log levels. The mapping 300 illustrates that as Z increases, the log level increases. During operation, as Z is evaluated or as C₂(E)+C₁(W) is evaluated, the logging mechanism can change the log level at which logging is performed.

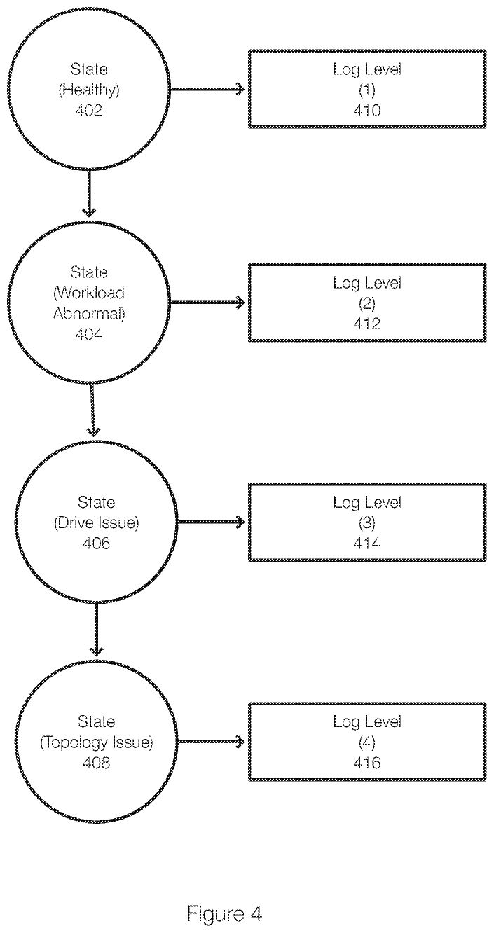

FIG. 4 discloses aspects of a performance regression telemetry example. In this example, the system (e.g., a data protection system) implements a logging mechanism that may vary or change the level at which logging is performed. This example includes four (4) log levels, however, the number of log levels is not limited. FIG. 4 illustrates states 402, 404, 406, and 408. State 402 represents a healthy state. State 404 is a workload abnormal state, state 406 is a drive issue state, and state 408 is a topology issue. In this example at state 402, the telemetry data may only matter when critical errors occur. In this example, the log level 410 associated with the state 402 is log level 1.

If the telemetry data collected from the system indicates that high IO latency is detected, but without IO (Input/Output) errors, the Markov process and/or transition matrix may predict a transition to state 404. As a result, the log level 210 may be changed to log level 412 or log level 2. At log level 410, only critical errors are dumped. At log level 412, blktrace logs may be collected.

More specifically, high IO latency without IO errors indicates that an unexpected workload change may be occurring. As a result, the IO pattern telemetry is collected. In addition, it may be possible to log IO workload change, as represented by runtime IO throughput, IO randomness, and average IO size.

When errors on a single drive occur, the system may transition to state 406. Because this may have been predicted, the log level 414 may have been enabled prior to the actual error occurring. This ensures that relevant and detailed logs are collected. At state 408, a system wide issue may be occurring. If state 408 is predicted from state 406, the log level 416 may be enabled such that all logs may be collected. At the highest log level, the generation/collection of logs is a significant operation and may only be performed at this state.

The amount of data collected can be substantial. For example, 24 bytes for a data point will generate 1 M unique time series for 12 hours at 1-minute intervals. That is equivalent to 17 GB. By enabling logging variability, the amount data generated from collecting logs or telemetry data can be controlled to data that is expected to be needed. Over time, this reduces dark data.

Thus, the logging mechanism is configured to predict a future state of the system or application using a state transition matrix. The log level is then proactively adjusted based on the predicted transitions such that telemetry data can be collected before the predicted state actually occurs. The timing of the change in log level may vary.

For example, if a drive issue is predicted (predicted state change from state 404 to state 406), the log level is increased from log level 412 to log level 414 proactively and before the system actually achieves state 406. Of course, if the telemetry data being collected and the transition matrix predicts a different state change, the log level can be adjusted accordingly.

The transition matrix can be updated continually or repeatedly and the probabilities can be continually or repeatedly updated. This allows the logging mechanism to determine whether the system is headed for steady state or for an anomalous state.

The logging mechanism, which may operate locally at the system and/or in the cloud (e.g., cloud compute, edge servers), is configured to dynamically adapt the log generation/collection. The logging mechanism may adjust, for example, setting in an application that controls the log level. Further, by intelligently collecting and generating logs, the overall dark data footprint is reduced and the energy consumed to store dark data can be reduced.

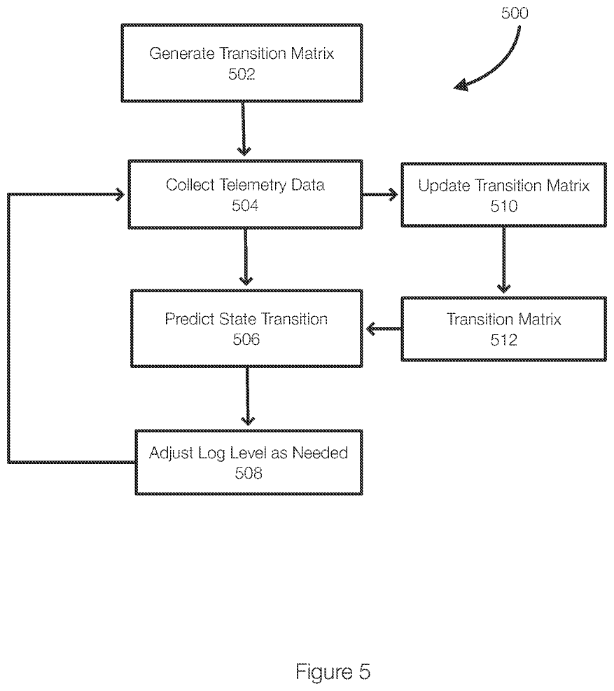

FIG. 5 discloses aspects of performing telemetry-based state transitions. The method 500 may include elements that are repeated fewer times. In FIG. 5, a transition matrix is generated 502. The transition matrix may be generated using historical log or existing log data. Once the system is operating, telemetry data may be collected 504. The system may be in a particular or initial state and the log level collected at 504 may be in accordance with the initial state of the system.

Using the collected telemetry data and/or the transition matrix, a state transition may be predicted 506. In one example, the prediction at 506 may be made using the transition matrix while the collected 500 telemetry data is used to update 510 the transition matrix 512. Thus, the transition matrix 512 is an input to the logging mechanism 506 that allows a state transition to be predicted. The log level is adjusted 508 based on the prediction. The method continues in this manner and the log level can be continually and predictively adjusted based on the transition matrix. The method 500 thus implements smart telemetry based transition prediction.

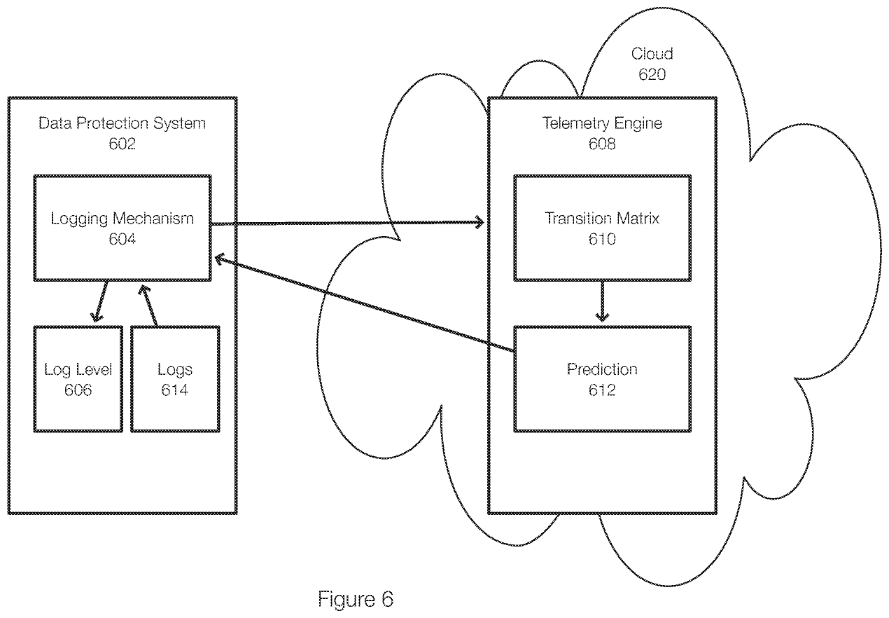

In one example, the logging mechanism is configured to collect the necessary data and transmit the data to a telemetry engine. FIG. 6 discloses aspects of a telemetry engine. FIG. 6 illustrates a data protection system 602 (or other application or system) that may be performing operations such as data protection operations. As the data protection operations are performed, a log level 606 may determine the extent or amount of log data that is generated. The logging mechanism 604 is configured to collect logs 614 and transmit the logs to a telemetry engine 608. The telemetry engine may include or have access to a transition matrix 610, which is based on historical log data and/or current telemetry data from the data protection system 602. The telemetry engine 608 can generate a prediction 612 using the transition matrix 610 and return the transition matrix or the prediction to the logging mechanism 604 or to the data protection system 602. The log level 606 is updated according to the prediction 612. By way of example only, the prediction is typically associated with both a specific state and a specific log level. Thus, the prediction 612 allows the log level 606 to be adjusted adaptively and dynamically based on current telemetry data, predicted state transitions, and the like. This ensures that the logs 614 are appropriate for the expected state transition.

The Markov chain process may be implemented as a discrete chain process or a continuous chain process. Embodiments of the invention advantageously make predictions based on the current state. Future and past states are independent. This is advantageous because it allows log levels to be determined based on the present state. The ability to set log levels based on the current or present state and the transition matrix can reduce the computing requirements of the data protection system. In other words, less time is spent processing historical data in an attempt to predict a future state. Rather, embodiments of the invention can predict the next state based solely on the current state.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or amore clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. An image of a VM may take the form of a .VMX file and one or more .VMDK files (VM hard disks) for example.

As used herein, the term ‘data’ is intended to be broad in scope. Thus, that term embraces, by way of example and not limitation, data segments such as may be produced by data stream segmentation processes, data chunks, data blocks, atomic data, emails, logs, objects of any type, files of any type including media files, word processing files, spreadsheet files, and database files, as well as contacts, directories, sub-directories, volumes, and any group of one or more of the foregoing.

It is noted with respect to the disclosure that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: determining a current state of a system, generating a prediction based on the current state and a state transition matrix, and updating a log level at the system based on the prediction, wherein the log level determines a size of log data collected from the system.

Embodiment 2. The method of embodiment 1, further comprising generating the transition matrix based on historical log data.

Embodiment 3. The method of embodiment 1 and/or 2, further comprising updating the state transition matrix based on the collected telemetry data.

Embodiment 4. The method of embodiment 1, 2, and/or 3, further comprising updating the log level before a predicted state associated with the prediction occurs, wherein the prediction is based on probabilities.

Embodiment 5. The method of embodiment 1, 2, 3, and/or 4, further comprising determining whether the system is trending towards steady state based on the state transition matrix, wherein the log level is reduced, wherein the log level is increased when the system is not trending towards steady state.

Embodiment 6. The method of embodiment 1, 2, 3, 4, and/or 5, further comprising collecting the telemetry data in accordance with the log level and storing the collected telemetry data in a cloud storage.

Embodiment 7. The method of embodiment 1, 2, 3, 4, 5, and/or 6, further comprising predictively adapting the log level.

Embodiment 8. The method of embodiment 1, 2, 3, 4, 5, 6, and/or 7, further comprising performing performance regression telemetry on the system, wherein the system is a data protection system performing data protection operations.

Embodiment 9. The method of embodiment 1, 2, 3, 4, 5, 6, 7, and/or 8, wherein states include a first state associated with a first log level and a second state associated with a second log level, wherein more telemetry data is collected for the second log level.

Embodiment 10. The method of embodiment 1, 2, 3, 4, 5, 6, 7, 8, 9, and/or 9, wherein analysis of the collected telemetry data and updating the transition matrix and generating the prediction are performed remotely from the system.

Embodiment 11. A method for performing any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

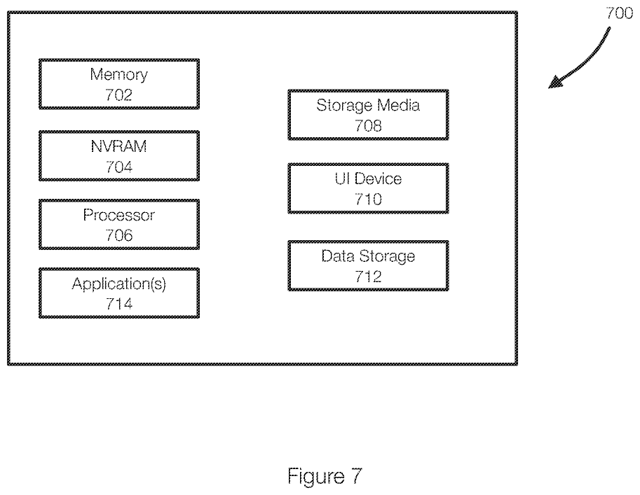

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
determining a current state of a system;
generating a prediction based on the current state and a state transition matrix;
updating a log level at the system based on the prediction, wherein the log level determines a size of log data collected from the system.

2. The method of claim 1, further comprising generating the transition matrix based on historical log data.

3. The method of claim 1, further comprising updating the state transition matrix based on the collected telemetry data.

4. The method of claim 1, further comprising updating the log level before a predicted state associated with the prediction occurs, wherein the prediction is based on probabilities.

5. The method of claim 1, further comprising determining whether the system is trending towards steady state based on the state transition matrix, wherein the log level is reduced, wherein the log level is increased when the system is not trending towards steady state.

6. The method of claim 1, further comprising collecting the telemetry data in accordance with the log level and storing the collected telemetry data in a cloud storage.

7. The method of claim 1, further comprising predictively adapting the log level.

8. The method of claim 1, further comprising performing performance regression telemetry on the system, wherein the system is a data protection system performing data protection operations.

9. The method of claim 1, wherein states include a first state associated with a first log level and a second state associated with a second log level, wherein more telemetry data is collected for the second log level.

10. The method of claim 1, wherein analysis of the collected telemetry data and updating the transition matrix and generating the prediction are performed remotely from the system.

11. A non-transitory storage medium having stored therein instructions that are executable by one or more hardware processors to perform operations comprising:
determining a current state of a system;
generating a prediction based on the current state and a state transition matrix;
updating a log level at the system based on the prediction, wherein the log level determines a size of log data collected from the system.

12. The non-transitory storage medium of claim 11, further comprising generating the transition matrix based on historical log data.

13. The non-transitory storage medium of claim 11, further comprising updating the state transition matrix based on the collected telemetry data.

14. The non-transitory storage medium of claim 11, further comprising updating the log level before a predicted state associated with the prediction occurs, wherein the prediction is based on probabilities.

15. The non-transitory storage medium of claim 11, further comprising determining whether the system is trending towards steady state based on the state transition matrix, wherein the log level is reduced, wherein the log level is increased when the system is not trending towards steady state.

16. The non-transitory storage medium of claim 11, further comprising collecting the telemetry data in accordance with the log level and storing the collected telemetry data in a cloud storage.

17. The non-transitory storage medium of claim 11, further comprising predictively adapting the log level.

18. The non-transitory storage medium of claim 11, further comprising performing performance regression telemetry on the system, wherein the system is a data protection system performing data protection operations.

19. The non-transitory storage medium of claim 11, wherein states include a first state associated with a first log level and a second state associated with a second log level, wherein more telemetry data is collected for the second log level.

20. The non-transitory storage medium of claim 11, wherein analysis of the collected telemetry data and updating the transition matrix and generating the prediction are performed remotely from the system.
